(19) United States
(12) Patent Application Publication
(10) Pub. No.: US 2012/0229830 A1
(43) Pub. Date: Sep. 13, 2012

(54) IMAGE FORMING APPARATUS AND IMAGE FORMING SYSTEM

(75) Inventor: Junichi Mori, Kawasaki-shi (JP)

(73) Assignee: CANON KABUSHIKI KAISHA, Tokyo (JP)

(21) Appl. No.: 13/412,566

(22) Filed: Mar. 5, 2012

(30) Foreign Application Priority Data
Mar. 8, 2011 (JP) 2011-050544

(51) Int. Cl. G06K 15/02

(52) U.S. Cl. 358/1.12

(57) ABSTRACT

There are included a converting unit configured to convert print data to a print data image for one side of the sheet; a converting unit configured to convert obtained code information to a code image; a generating unit configured to generate a code-embedded image obtained by synthesizing the code image with the print data image; a determining unit configured to determine whether or not to print the code-embedded image only on one side of the sheet: and a printing unit configured to print the code-embedded image on one side and to print the code image on the other side if the determining unit determines to print only on one side.

### BACKGROUND OF THE INVENTION

1. Field of the Invention

The present invention relates to an image forming apparatus which synthesizes an image including a code and prints it on a paper medium and particularly relates to an image forming apparatus which prints an image including a code on both sides of a paper medium.

2. Description of the Related Art

Japanese Patent Laid-Open No. 2009-284472 discloses that, if a printed, matter has a code such as a QR code, the code is detected from image data obtained by scanning the printed matter and then the detected code is decoded. If duplication, permission information is obtained as a result of decoding the detected coder a printed matter on which the image data is printed is generated and ejected. On the other hand, if duplication prohibition information is obtained, a printed, matter is not generated. Moreover, it discloses that a printed matter is not generated, either, if a code cannot be detected from the image data. That is, a printed matter is generated only it the image data includes a code indicating duplication permission, information.

Here, such a case is assumed that in a printed matter to be copied, there is a code indicating duplication permission information on a front side (or a back side), and there is not a code on the back side (or the front side).

In the case of both-side copying of such a printed matter in accordance with the invention described in Japanese Patent Laid-Open No. 2009-284372, the back side not including the code is not to be copied. As a result, it is assumed that even though the front side includes the duplication permission, copying is not performed. Therefore, in the above Japanese Patent Laid-Open there is a problem that if a side has duplication permission information and the other side does not have a code, copying is not performed.

The present invention was made in view of the above problem and provides an image forming apparatus which prints an image including a code indicating duplication permission or duplication prohibition without degrading a security level.

### SUMMARY OF THE INVENTION

In order to solve the above problem, an image forming apparatus according to the present invention is an image forming apparatus capable of printing on the both sides of a sheet and includes a converting unit configured, to convert print data to a print data image for one side of the sheet, a converting unit, configured to convert obtained code information to a code image, a generating unit configured to generate a code-embedded image obtained by synthesizing the code image with the print data image, a determining unit configured to determine whether or not to print the code-embedded image only on one side of the sheet, and a printing unit configured to print the code-embedded image on one side and to print the code image on the other side if the determining unit, determines to print, only on one side.

According to the present invention, an image including a code indicating duplication permission or duplication prohibition can be printed on both sides of the printed matter.

Further features of the present invention will become apparent from the following description of exemplary embodiments (with reference to the attached drawings).

### BRIEF DESCRIPTION OF THE DRAWINGS

FIG. 1 is a diagram illustrating an image forming system according to Embodiment 1;

FIG. 2 is a flowchart according to printing processing in each embodiment;

FIG. 3 is a flowchart according to both-side printing processing in Embodiment 1;

FIG. 4 is a diagram for explaining a processing example of the both-side printing processing;

FIG. 5 is a diagram illustrating an image forming system according to Embodiment 2 and Embodiment 3;

FIG. 6 is a diagram showing the relationship of FIGS. 6A and 6B;

FIG. 6A is a flowchart according to the both-side printing processing in Embodiment 2;

FIG. 6E is a flowchart according to the both-side printing processing in Embodiment 2;

FIG. 7 is a diagram showing the relationship of FIGS. 7A and 7B;

FIG. 7A is a flowchart according to the both-side printing processing in Embodiment 3;

FIG. 7B is a flowchart according to the both-side printing processing in Embodiment 3; and

FIG. 8 is a diagram illustrating an example of an operation screen of an image forming apparatus.

### DESCRIPTION OF THE EMBODIMENTS

A best mode for carrying out the present invention will be described below by referring to the attached drawings.

### Embodiment 1

In this embodiment, if a code image is to be printed on the front side, the same code image is printed on the back side as described below in detail (S2006, S3014). Such processing is not executed in the case of one-side printing (See S2003), because of preventing a printing speed from becoming too low. That is, if printing is made also on the back side in the case of the one-side printing, the printing speed becomes the half and thus, the processing is not executed. However, if the printing speed is not considered, the code image may be printed on the back side also in the one-side printing.

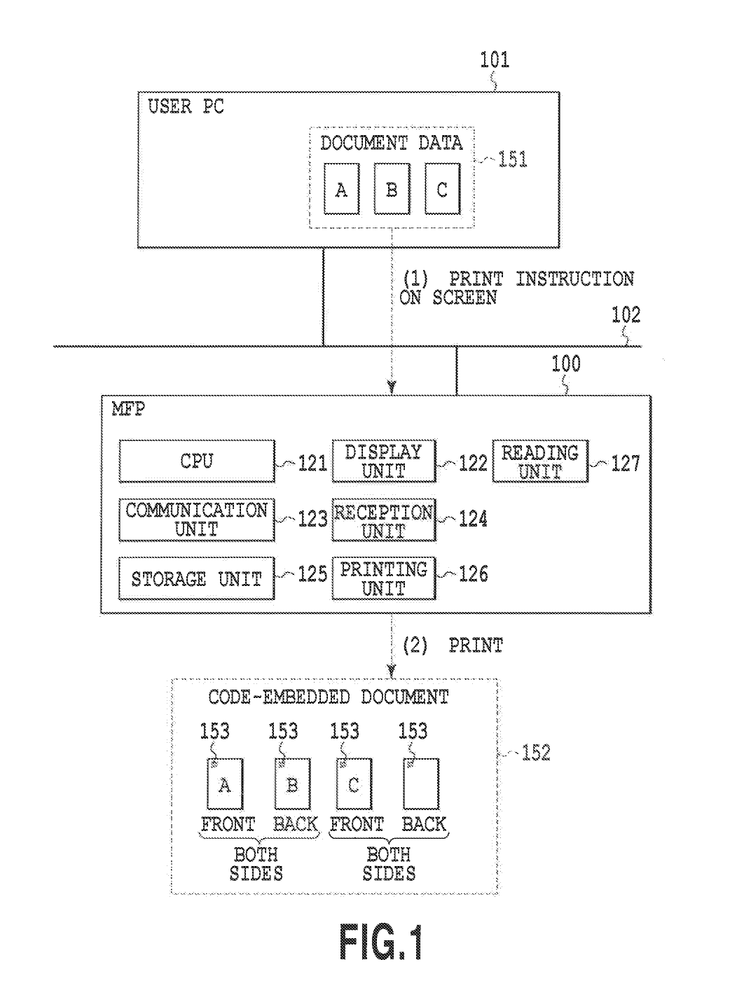

FIG. 1 is a diagram illustrating an image forming system in Embodiment 1 according to the present invention. The system is configured such that a user PC 101 of an information processor and an MFP 100 of the image forming apparatus are connected, to each, other via a network 102 such as LAN.

The user PC 101 is connected to a display, a keyboard, a mouse and the like and can select and execute a plurality of typos of software processing. Moreover, the user PC 101 communicates with the MFP 100 via the network 102. It a user operates the user PC 101, the user PC 101 generates print data on the basis of document data 151 and transmits the print data to the MFP 100. The print data is a collection of drawing instructions to be processed by the MFP 100. More specifically, the print data is data, for example, composed oh PDL (Pace Description Language). When the user PC 101 transmits the print data, information of various printing settings such as which of one side and both sides the print is to be made in the MFP 100 and the like is also added, to the print data and transmitted to the MFP 100.

FIG. 1 illustrates an example of a document composed of three pages including any one of characters “A”, “B” and “C” as an example of the document data 151. It an instruction is given to print an odd-page document as above, the print data to be transmitted to the MFP 100 indicates printing three pages. That is, if this print data is processed to be printed on both-side, since there is no print data corresponding to the back page of the last sheet (second sheet), it was left to be a blank page.

The MFP 100 analyzes the received print data, converts it to a print image for one side for each page, prints it on paper (the formation of an image) and ejects a printed matter. At that time, according to the added information of the various printing settings such as one-side printing or both-side printing and the like the process is performed.

The MFP 100 includes a CPU 121, a display unit 122, a communication unit 123, a reception unit 124, a storage unit 125, a printing unit 126, a reading unit 127 and the like.

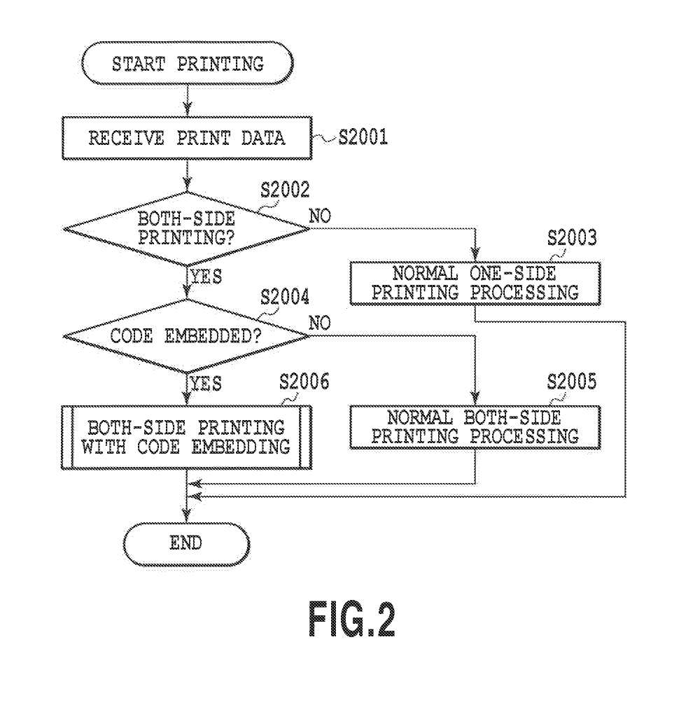

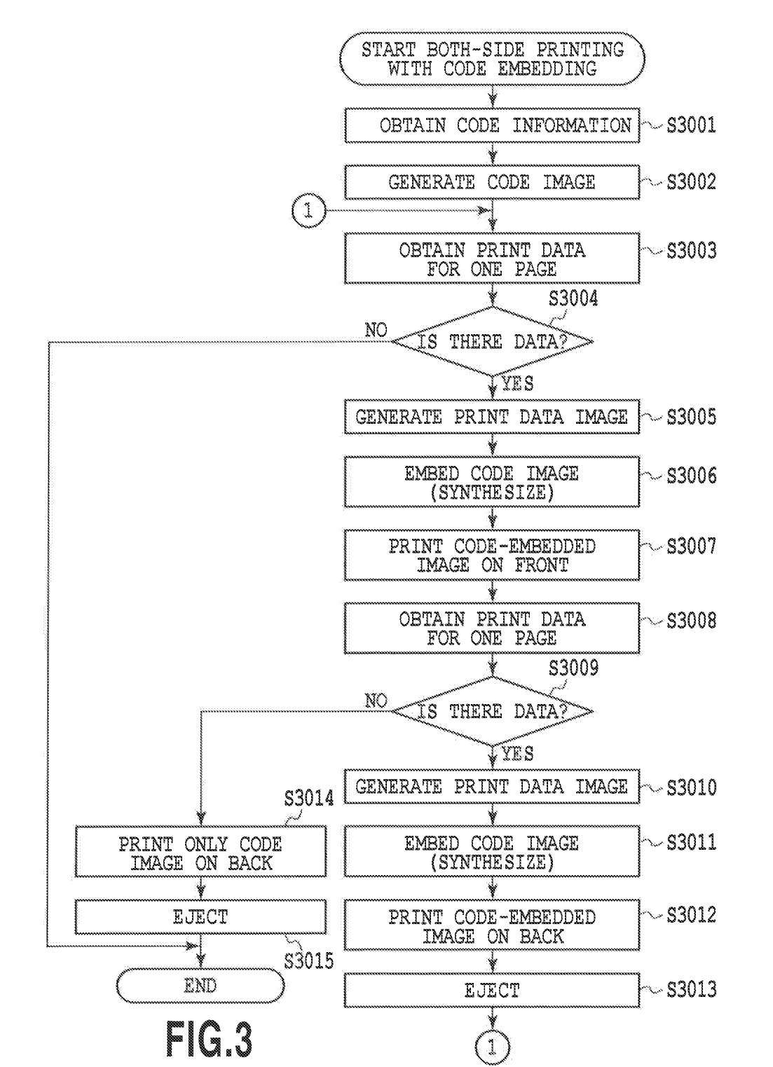

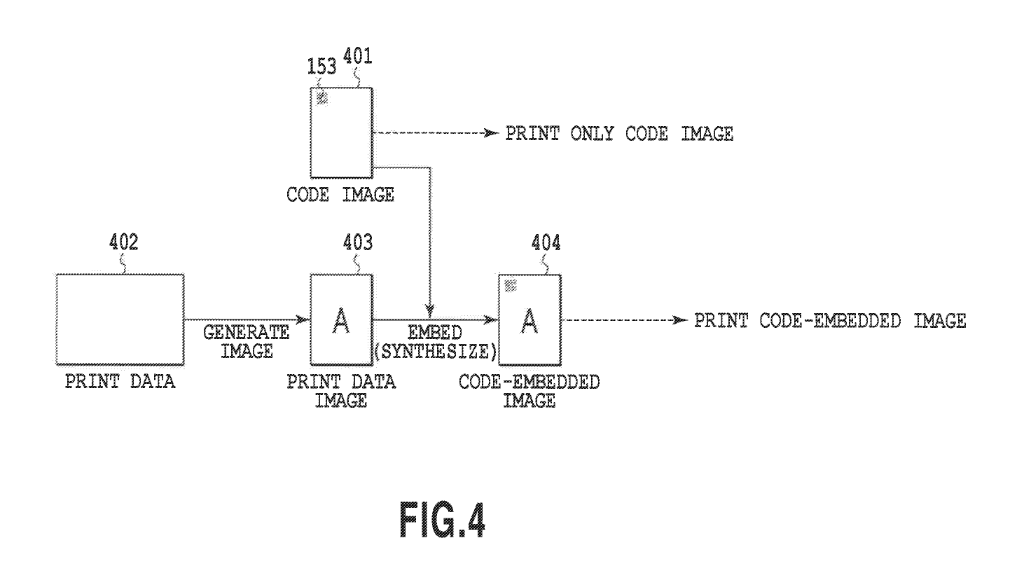

The storage unit 125 stores a program according to the flow shown in FIGS. 2 and 3. The CPU 121 comprehensively controls processing of each component of the MFP 100 by executing the program inside the storage unit 125. The storage unit 125 further has a storage region for temporarily storing print data received from the user PC 101. The storage unit 125 further has a storage region for storing various images as illustrated, in FIG. 4. These various images include images extracted based, on the analysis of the print data (hereinafter referred to as print data image) and a code image including information for permitting/prohibiting duplication and the like.

The communication unit 123 is used, for communication with the user PC 101 through the network 102 such as LAN, the Internet, and a wired cable.

The reading unit 127 optically reads a manuscript and generates image data. The reading unit 127 can continuously read a plurality of manuscripts and also can read both sides of the manuscript. An image read by the reading unit 127 is stored in the storage unit 125.

The printing unit 126 reads out the image from the storage unit 125 and performs printing. The printing unit 126 can also perform both-side printing. A copy function is to read the manuscript by the reading unit 127 and then to print out by the printing unit 126.

The reception unit 124 receives an execution instruction on a job such as copying through a key input (such as hard key or soft key).

The display unit 122 displays a job state, an alarm, an error, a setting of the MFP 100 and the like.

The code-embedded document 152 is a printed matter to be outputted as the result of printing processing of code embedding in the MFP 100 of this embodiment. In the code-embedded document 152, for example, the letter “A” is printed on the front side of the first sheet and the letter “B” on the back side. Moreover, the letter “C” is printed on the front side of the second, sheet and a code image on the back side. A QR code 153, which is a two-dimensional code, is added as a code image on all the printed faces of the code-embedded document 152. This QR code 153 includes information indicating either of duplication permission information indicating that duplication of the manuscript, is permitted as digital information or duplication prohibition information, indicating that the duplication is prohibited.

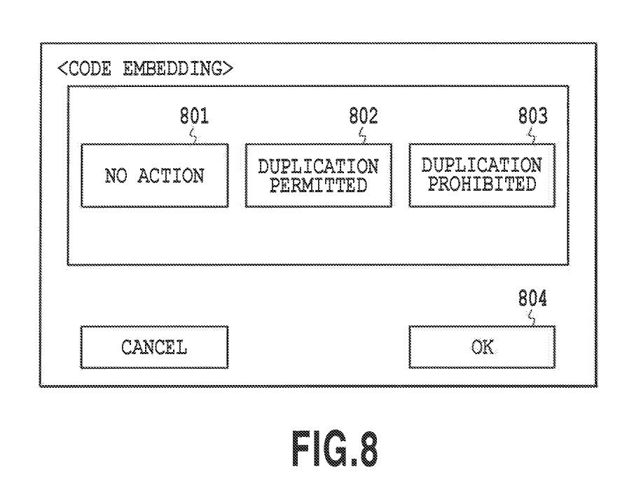

Subsequently, a setting screen of the MFP 100 will be described, by using FIG. 8.

A user can select code embedding setting through the setting screen as illustrated in FIG. 8. The code embedding setting specified by a user is either inclusion of duplication permission information or duplication prohibition information in a code image or no code embedding.

If the user selects “duplication permitted” 802 in a state in which “<Code embedding” is displayed on the display unit 122, the reception unit 124 receives the selection by a user. Then the CPU 121 sets the code embedding setting of the MFP 100 to “duplication permitted”. In this case, the CPU 121 controls such that the code embedding of duplication permission is executed in printing processing by the MFP 100.

If the user selects “duplication prohibited” 803, the CPU 121 sets the code embedding setting of the MFP 100 to “duplication prohibited”. In this case, the CPU 121 controls such that, the code embedding of duplication prohibition is executed, in the printing processing by the MFP 100.

If the user selects “no action” 801, the CPU 121 sets the code embedding setting of the MFP 100 to “no action”. In this case, the CPU 121 controls such that an operation proceeds without code embedding in the printing processing by the MFP 100.

Subsequently, a flow of the operation in Embodiment 1 (FIG. 2) will be described.

FIG. 2 is a flowchart illustrating the printing processing when the communication unit 123 of the MFP 100 receives print data from the user PC 10.1. The flow of an operation in each step in the flowchart illustrated, in FIG. 2 is realized when the CPU 121 in the MFP 100 executes the program in the storage unit 125 and controls each component of the MFP 100.

When the communication unit 123 receives the print data, the CPU 12.1 controls the communication unit 123 and the storage unit 125 to store the received print data in the storage unit 125 at Step S2001.

At Step S2002, the CPU 121 analyzes the print data stored in the storage unit 125 and determines which of one-side and both-side print instruction is included.

Here, if the print instruction is related, to one-Side print, the CPU 121 controls such that normal one-side printing processing is executed at Step S2003 and ends the flow. On the other hand, if the print instruction is related, to both-side, the CPU 121 determines whether the “code embedding setting” is the setting to embed a code or not at step S2004. This code embedding setting is specified by the user as explained by referring to FIG. 8.

Here, if it is determined that the setting is not to embed a code, the CPU 121 controls such that normal both-side printing is executed at Step S2005. On the other hand, if it is determined that the setting is to embed a code, the CPU 121 controls such that the both-side printing with code embedding is executed at Step S2006. The processing at Step S2006 will be described, in detail by using a flowchart in FIG. 3 later. Also, the description will be made by using FIG. 4.

FIG. 3 is a flowchart for explaining in detail the both-side printing processing when the both-side printing with code embedding is executed at Step S2006 in FIG. 2. The flow of an operation at each Step in the flowchart illustrated, in FIG. 3 is realized when, the CPU 121 in the MFP 100 executes the program in the storage unit 125 and controls each component of the MFP 100.

When the both-side printing with code embedding is started, the CPU 121 obtains code information to be embedded in printing processing at Step S3001. That is, the CPU 121 obtains either or “duplication permitted” or “duplication prohibited” specified by the user in the “code embedding setting” illustrated in FIG. 8. The flowchart in FIG. 3 is processing when it is determined at Step S2004 that a code is to be embedded, and thus, “no action” cannot be selected for the “code embedding setting”.

Then, at Step S3002, the CPU 121 generates a code image on the basis of the code information specified by the “code embedding setting”. That is, if the code information is “duplication permitted”, a code image including the duplication permission information is generated. On the other hand, if the code information is “duplication prohibited”, a code image including the duplication prohibition information is generated. For example, the code image is a code image 401 as illustrated in FIG. 4 and includes a QR code 153 obtained by encoding the code information.

Then, the CPU 121 stores the generated code image in a storage region in the storage unit 125.

At Step S3003, the CPU 121 obtains print data of one page from the print data (print data 402 in FIG. 4) stored in the storage unit 125. Then, at Step S3004, the CPU 121 determines if there is print data of one page or not. If it is determined that there is no print data here, the print data has been fully processed, end the processing is finished. On the other hand, if the CPU 121 determines that there is print data of one page at Step S3004, the routine proceeds to step S3005, and the CPU 121 analyses the print data and converts it to a print data image (a print data image 403 in FIG. 4, for example). Then, the CPU 121 stores the converted, print data image in the storage region of the storage unit 125.

Subsequently, at Step S3006, the CPU 121 embeds the code image in the print data image by synthesizing the print data, image with the code image and generates a code-embedded image (a code-embedded image 404 in FIG. 4). The CPU 121 stores the generated, code-embedded image in the storage region in the storage unit 125. Then, at Step S3007, the CPU 121 controls the printing unit 126 to print the code-embedded image on the front side of the sheet.

At Step S3008, the CPU 121 obtains print data of the subsequent one page from the storage unit 123. Then, at Step S3009, the CPU 121 determines if there is print data for one page or not. If it is determined that there is no print data, the CPU 121 controls the printing unit 12G to print only the code image (the code image 401 in FIG. 4, for example) on the back side of the sheet at Step S3014. Then, at Step S3014, the CPU 121 controls the printing unit 126 to eject the printed sheet. As a result, regarding the printed sheet the code-embedded, image is printed on the front side, and the code image is printed on the back side. Then, the print data has been fully processed, and then the processing is finished.

On the other hand, if the CPU 121 determines at Step S3009 that there is print data of one page, the routine proceeds to Step S3010, and the CPU 121 analyzes the print data and converts it to a print data image. The CPU 121 stores the print image data in the storage region of the storage unit 125.

Subsequently, at Step S3011, the CPU 121 synthesizes the print data image with the code image so as to embed the code image in the print data, image and generates a code-embedded image. Then, the CPU 121 stores the generated, code-embedded image in the storage region of the storage unit 125. Then, at Step S3012, the CPU 121 controls the printing unit 126 to print the code-embedded image on the back side of the sheet.

At Step S3013, the CPU 121 controls the printing unit 126 to eject the sheet. As a result, the sheet on which the code-embedded image is printed on both the front and back sides is ejected. Then, the routine proceeds to the above-described Step S3003 and the printing processing is repeated for the subsequent page of the print data.

As described above, when the CPU 121 controls each component in the MFP 100, the code-embedded image is printed on the front side if the document data 151 is the print data of odd pages, and the both-side printed, sheet (last sheet) on which only the code image is printed on the back side is ejected. As a result, such an advantage can be obtained that a printed matter whose duplication of the front face for which duplication is permitted can be output in both-side copying after the printing.

### Embodiment 2

Embodiment 1 illustrates an example in which the code image is printed on the back side or the last sheet it there is no print data on the back side of the last sheet of the sheets to be printed.

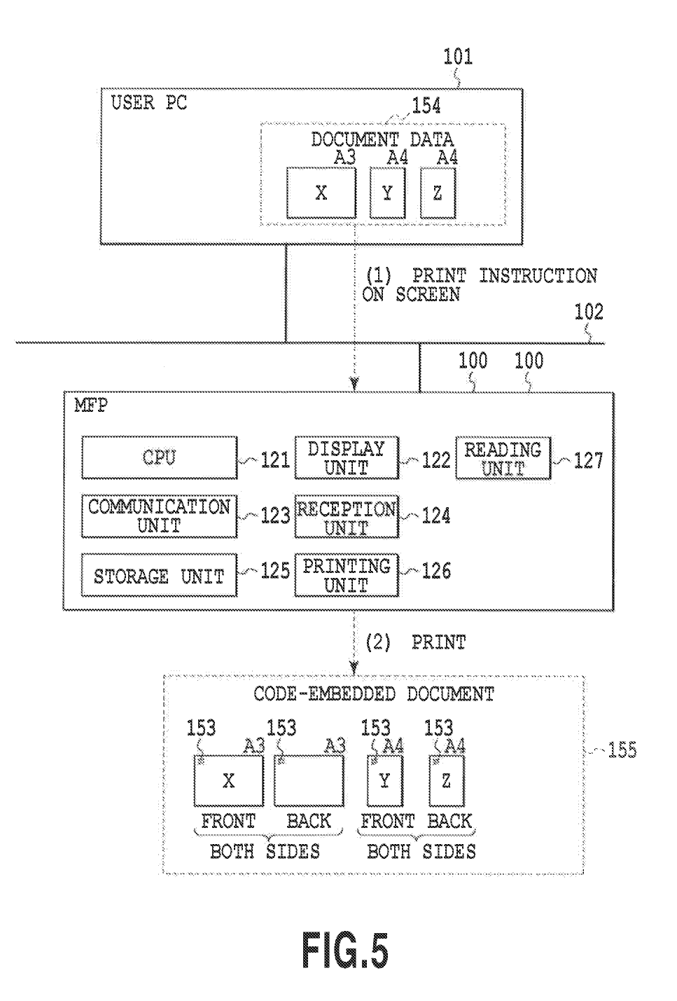

However, this is not the only case in which a printed matter on which a code image is present only on one side is generated. For example, there can be a case in which a command, to order both-side printing of print, data having pages with different sizes (for example, the size of the first half pages of the document data is A3 type and the size of the second half pages is A4 type, for example) is transmitted. In this case, the second half pages are printed on the sheet with the size different from that of the first, half pages (See FIG. 5). Such, a case can occur in the middle of sheets other than the last sheet as described in Embodiment 1.

In Embodiment 2, an example in which even if there is print data only for one side in any sheet according to printing including the last sheet, a printed matter whose duplication of the face for which duplication is permitted, can be output in both-side copying after printing will be described.

Since Embodiment 2 is an extension of Embodiment 1, only the difference from Embodiment 1 will be described, below.

FIG. 5 is a diagram illustrating an image forming system according to Embodiment 2. In the system illustrated in FIG. 5, the configuration of each device is similar to those in Embodiment 1. However, document data 154 and a code embedded document 155 to be printed are different from those in Embodiment 1.

The document data 154 illustrates an example of a document composed of three pages, that is, “X”, “Y”, and “Z”. It is assumed that a printing instruction is made to print the pages with different sizes that is, A4 type size for the “X” page and the A3 type size for the “Y” and “Z” pages. When a both-side printing instruction is made to sheets with different sizes in the single document data as above, as the result of printing processing of code embedding in the MFP 100 in this embodiment, the code embedded, document 155 is printed. The code embedded, document 155 includes “X” printed on the front of the first sheet with the A3 type size and only a code image on the back. Then, “Y” is printed on the front and “Z” on the back of the second sheet with the A4 type size. That is because “Y” is deviated and printed on the front face of the subsequent page, not on the back face of “X” due to the specification described above since “X” and “Y” have different sizes.

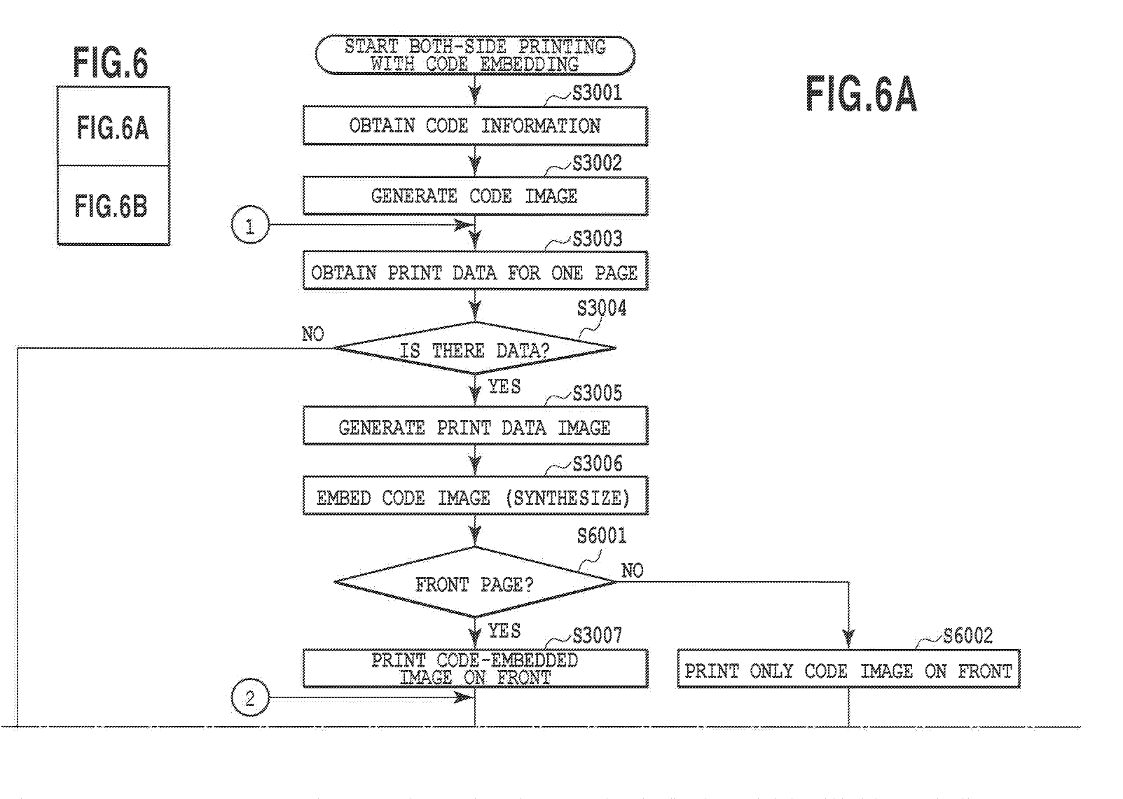

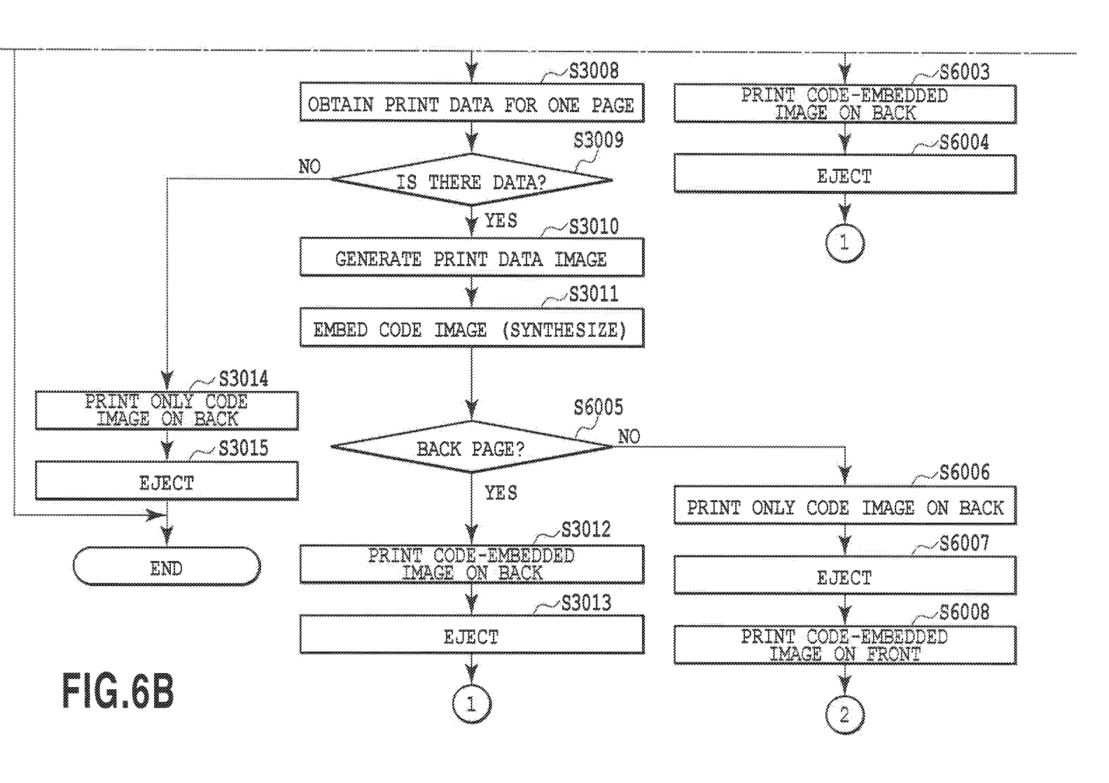

Subsequently, the flow of an operation in Embodiment 2 will be described by using FIGS. 6A and 6B. FIGS. 6A and 6B illustrates processing according to the both-side printing processing sit 32006 in the printing processing illustrated in FIG. 2. In FIGS. 6A and 6B, the same reference numerals are given to the same processing as those at Steps illustrated in FIG. 3.

In addition, the storage unit 125 stores the program illustrated in the flowchart in FIGS. 6A and 6B. The flow of an operation at each Step in the flowchart illustrated in FIGS. 6A and 6B is realised when the CPU 121 in the MFP 100 executes the program in the storage unit 125 and controls each component of the MFP 100.

When a code-embedded image is generated at Step S3006, the CPU 121 determines if the code-embedded image is to be printed on the front or not at Step S6001. Here, if the CPU 121 determines that the image is printed on the front, the routine proceeds to Step S3007. On the other hand, if the CPU 121 determines that the image is not printed on the front, that is, the image is to be printed on the back, the routine proceeds to Step S6002. The CPU 121 controls she printing unit 126 to print only the code image on the front of the sheet at Step S6002. Then, the CPU 121 controls the printing unit 126 to print the cods-embedded image (generated at step S3006) on the back of the sheet at Step S6003.

Then, the CPU 121 controls the printing unit 126 to eject the sheet, set Step S6004. As a result, a sheet on which only a code image is printed on the front, and a code-embedded image is printed on the back is ejected. As described above, even if there is print data only on the back face and there is no print data on the front face, such an advantage can be obtained that a user can obtain a printed, matter whose duplication of the back face for which duplication is permitted can be output in both-side copying after the printing.

Moreover, if the code-embedded image is printed on the front at Step S3007 and then, the code-embedded image is generated at Step S3011, the CPU 121 determines if the code-embedded, image is to be printed on the back at Step S6005.

A specific example of this processing will be described by using FIG. 5. After “X” in FIG. 5 is printed on the front of the sheet at Step S3007, a code-embedded image of “Y” is generated at Step S3011 and the routine proceeds to Step S6005. At Step S6005, the CPU 121 determines if the code-embedded image of “Y” generated, at Step S3011 is to be printed on the back page of “Y” at Step S3007. Here, “X” has the A3 type size and “Y” has the A4 type size, that is, a command which orders both side printing of the print data with pages having different sizes is sent. In this case, the CPU 121 executes control such that “Y” on the subsequent page is printed on a sheet different from that for “X” on the previous page. That is, the CPU 121 determines that the code-embedded image of “Y” is not printed on the back (of the sheet for “X”).

If the CPU 121 determines to print on the back at Step S6005, the routine proceeds to Step S3012. On the other hand, if the CPU 121 determines not to print on the back, that is, to print on the front, the routine proceeds to Step S6006. Then, the CPU 121 controls the printing unit 126 to print, only the code image on the back of the sheet at Step S6006. Then, at Step S6007, the CPU 121 controls the printing unit 156 to elect the sheet. As a result, a sheet, on which only the code image is printed, on the front and the code-embedded image is printed on the back is ejected. Then, the CPU 121 controls the printing unit 126 to print the code-embedded image (generated at Step S3011) on the front of the sheet at Step S6008. Then, the routine proceeds to Step S3008 and continues the processing.

As described above, even if there is print data only on the front face and there is no print data on the back face, such an advantage can be obtained that a user can obtain a printed matter whose duplication of the front face for which duplication is permitted can be output in both-side copying after printing.

In Embodiment 2, the example of “pages with different sizes” is illustrated as an example in which there is print data only on the front face, but there is also an example in which there is print data only on the back face and this will be described supplementarily.

The PDL commands include a command to specify on which of the front and back faces of the print data is to be printed for each page. For example, in the case of the print data including the PDL command specifying the back face, the print data is printed on the back face and there is no print data on the front face.

For example, if the print data at Step S3005 includes the “PDL command specifying the back face”, the CPU 121 determines that printing should, performed on the back face at Step S6001 (not on the front face). As a result, only the code image is printed, on the front face at Step S6002 to Step S6003, and a sheet on which the code-embedded image is printed on the back face is ejected at Step S6004. As described above, even if there is print data only on the back face and no print data on the front face, an advantage is obtained that a user can obtain a printed matter whose duplication oh the back face for which duplication is permitted can be output in both-side copying after printing.

### Embodiment 3

In Embodiment 1 and Embodiment 2, the example in which only the code image is printed sill the time on the face of a sheet where there is no print data if setting indicates code embedding is illustrated.

Here, if the code embedding setting is “duplication prohibited”, a code image including the duplication, prohibition information is embedded. In that case, since the face on which a duplication prohibition code is printed, cannot be copied in the first place, no particular harm is done if there is no code on the other face. In other words, there is no need, to print only a code image on the other face. Therefore, it is only sufficient, to print a code image on the opposite face only if the code image including the code information of duplication permission is to be embedded on the one side.

Thus, in this embodiment, an example in which only a code image is printed on the face on which there is no print data only in the setting of embedding a code of duplication permission, will be described.

Since Embodiment 3 is an extension of Embodiment 2, only the difference from Embodiment 2 will be described below.

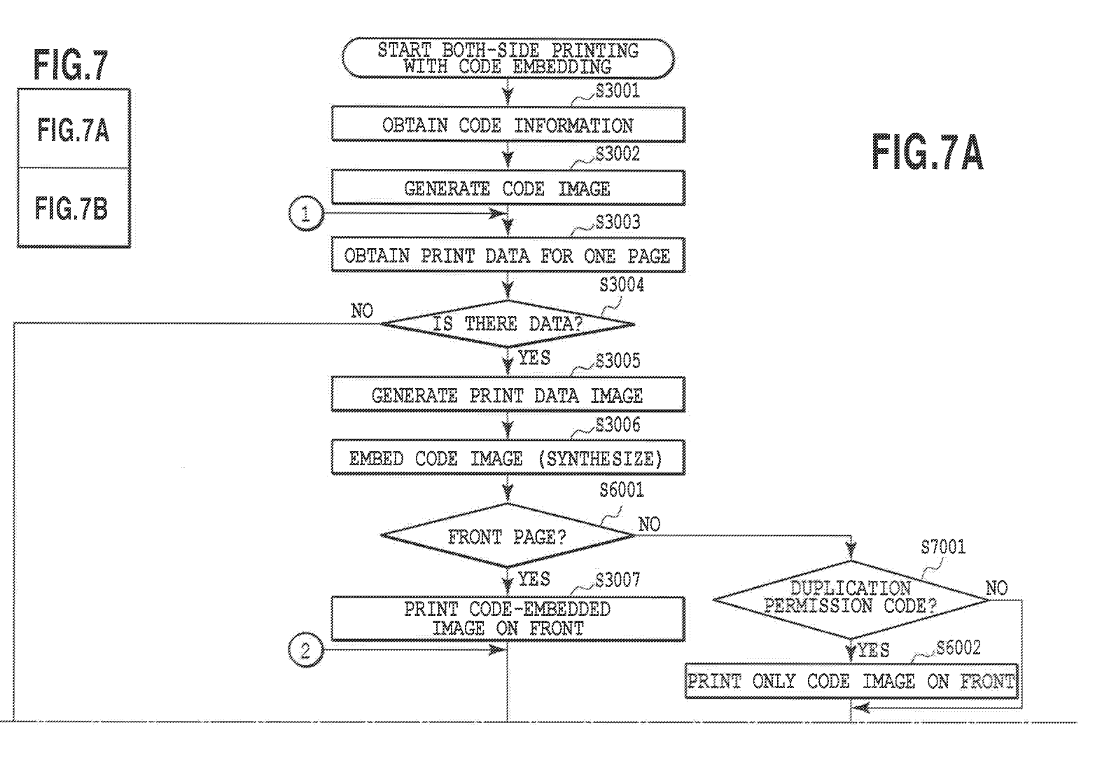

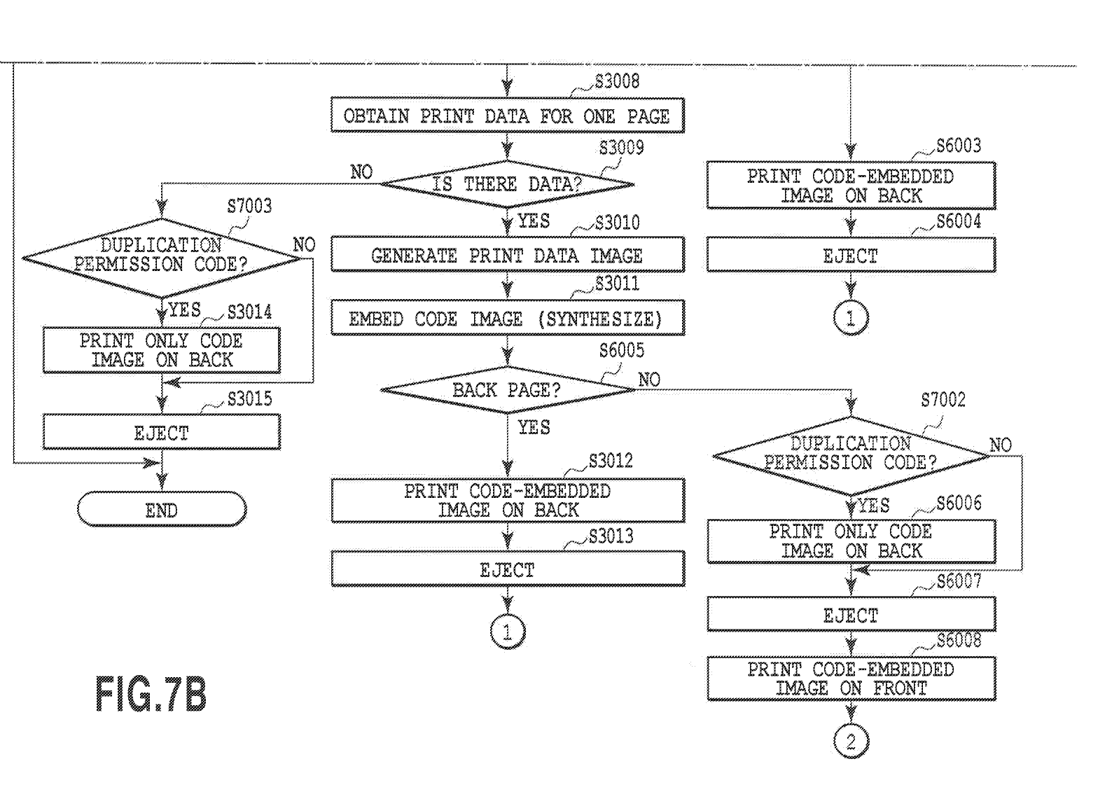

The flow of an operation in Embodiment 3 will be described by using FIGS. 7A and 7B. FIGS. 7A and 7B illustrates processing according to the both-side printing processing at S2006 in the printing processing illustrated in FIG. 2. In FIGS. 7A and 7B, the same reference numerals are given to the same processing as those at Steps illustrated in FIGS. 6A and 6B.

The storage unit 125 stores the program illustrated in the flowchart in FIGS. 7A and 7B. The flow of an operation at each Step in the flowchart illustrated in FIGS. 7A and 7B is realised, when the CPU 121 in the MFP 100 executes the program in the storage unit 125 and controls each component of the MFP 100.

If the CPU 121 determines at Step S6001 that the code-embedded image is not printed on the front, that is, the image is to be printed on the back, the routine proceeds to Step S7001. The CPU 121 determines at Step S7001 whether the code image is a code of duplication permission or not. Here, if the CPU 121 determines that the code is a code of duplication permission, only the code image is printed at Step S6002 on the front of the sheet, and the routine proceeds to Step S6003. On the other hand, if the CPU 121 determines that the code is not a code of duplication permission, printing of only the code image is not performed (printing is stopped), and the routine proceeds to Step S6003.

As described above, processing of printing only a code image on the face on which there is no print data is executed only if a code to be embedded is duplication permission.

Moreover, if the CPU 12.1 similarly determines at Step S6005 that the code-embedded image is not printed on the back, that is, the image is to be printed on the front, the routine proceeds to Step S7002. At Step S7002, the CPU 121 determines if the code image is a code of duplication permission or not. Here, if the code is determined to be a code of duplication permission, the routine proceeds to Step S6003 without printing only the code image is printed on the back of the sheet at Step S6006, and the routine proceeds to Step S6003. On the other hand, if the code is determined not to be a code of duplication permission, the routine proceeds to Step S6003 without printing only the code image.

As described, above, only if the code to be embedded is duplication permission, processing of printing only the code image on the face on which there is no print data is executed.

Moreover, if the CPU 121 similarly determines at Step S3009 that there is no data for the subsequent one page, the routine proceeds to Step S7003. The CPU 121 determines at Step S7003 whether the code image is a code of duplication permission or not. Here, if the code is determined to be a code of duplication permission, only the code image is printed on the back of the sheet at Step S3014, and the routine proceeds to Step S3015. On the other hand, if the code is determined not to be code information of duplication permission, the routine proceeds to Step S3015 without printing only the code image.

In any case, if the processing of printing only the code image on the face where there is no print data is executed, the printing is performed only if the code information included in the code image to be embedded is duplication permission and thus, efficiency of printing processing is improved.

### Other Embodiments

In the above embodiments, a QR code, which is a two-dimensional code, is used as an example of the code, but use of the QR code is not limiting, and any code such as an ST code, a barcode, a mark, and the like can be used, as long as information can be added thereto.

In the above embodiments, an MFP is exemplified as an image forming apparatus, but that is not limiting. Any device including a printer can be used as long as the device is capable of image formation.

In the above embodiments, the example in which document data is received from a user PC is described, but information obtained by reading information on paper by the reading unit of the MFP, for example, may be used as document data.

The storage unit 125, which is a storage medium in the above embodiments, may be any medium (BOB or RAM, for example) as long as it can store digital information.

In the above embodiments, the example in which the code embedding setting is set and held in the image forming apparatus is described, but that is not limiting. For example, the setting may be made on the user PC side and added to the print data as information of printing setting and transmitted to the image forming apparatus.

Moreover, the object of the present invention can be also achieved if a computer reads out and executes a program from a storage medium storing the program which realizes the procedures of the flowcharts illustrated in the embodiments. In this case, the program itself which is read out of the storage medium realizes the functions of the above-described embodiment. Thus, this program and the storage medium storing the program can also constitute the present invention.

### Other Embodiments

Aspects of the present invention can also be realized by a computer of a system, or apparatus (or devices such as a CPU or MPU) that reads out and executes a program recorded on a memory device to perform the functions of the above-described embodiment (s), and by a method, the steps of which are performed by a computer of a system or apparatus by, for example, residing out and executing a program recorded on a memory device to perform the functions of the above-described embodiment (s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No, 2011-050544, filed Mar. 8, 2011, which is hereby incorporated by reference herein in its entirety.

What is claimed is:

1. An image forming apparatus capable of printing on both sides of a sheet, comprising:
a converting unit configured to convert print data to a print data image for one side of the sheet;
a converting unit configured to convert obtained code information to a code image;
a generating unit configured to generate a code-embedded, image by synthesizing the code image with the print data image;
a determining unit configured to determine whether or not to print the code-embedded image only on one side of the sheet: and
a printing unit configured to print the code-embedded, image on one side and to print the code image on the other side if the determining unit, determines to print only on one side.

2. The image forming apparatus according to claim 1, wherein
the code information, includes duplication permission information or duplication, prohibition information.

3. The image forming apparatus according to claim 2, wherein
if the code information includes the duplication prohibition information, the printing unit stops printing of the code image on the other side.

4. The image forming apparatus according to claim 1, wherein the code image includes a QR code.

5. An image terming system in which an information processor and an image forming apparatus are connected, wherein
the image processor includes
a converting unit configured to convert print data to a print data image for one side of a sheet, and wherein
the image forming apparatus includes:
a converting unit configured to convert obtained code information to a code image;
a generating unit configured to generate a code-embedded image by synthesizing the code image with the print data: image;
a determining unit configured to determine whether or not to print the code-embedded image only on one side of the sheet: and
at printing unit configured to print the code-embedded image on one side and to print the code image on the other side if the determining unit determines to print only on one side.
